(19) United States
(12) Patent Application Publication
(10) Pub. No.: US 2026/0100965 A1
(43) Pub. Date: Apr. 9, 2026

(54) CONTEXT-BASED THREAT DETECTION

(71) Applicant: Google LLC, Mountain View, CA (US)

(72) Inventors: Daniel Wachdorf, San Antonio, TX (US); Erik Ringdahl, Stockholm (SE)

(21) Appl. No.: 18/910,495

(22) Filed: Oct. 9, 2024

(51) Int. Cl. H04L 9/40

(52) U.S. Cl. CPC H04L 63/1433

(57) ABSTRACT

A system and methods are disclosed for personalized threat detection. The method includes identifying in an event log of a cloud environment, a set of log records matching a simulated attack path of a plurality of simulated attack paths that are applicable to the cloud environment by security analytics platform. Each simulated attack path of the plurality of simulated attack paths comprises a respective plurality of expected operations to be performed in order to gain unauthorized access to a resource of a plurality of resources of the cloud environment. Responsive to identifying the set of log records matching the simulated attack path, the method notifies an entity associated with the cloud environment of an attack on the resource of the cloud environment.

### TECHNICAL FIELD

Aspects and implementations of the present disclosure relate to context-based threat detection.

### BACKGROUND

A security analytics platform can ingest data from computing resources (e.g., a computing system) in order to detect and respond to security threats on those computing resources. The ingested data can include event logs from devices and applications of the computing resources, network traffic data, or other data generated by or provided by the computing resources. The security analytics platform can then analyze the data, for example, by identifying patterns or anomalies in the data that can indicate a security threat for the computing resources.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for personalized threat detection. A set of log records matching a simulated attack path of a plurality of simulated attack paths that are applicable to a cloud environment is identified in an event log of the cloud environment. Each simulated attack path of the plurality of simulated attack paths includes a respective plurality of expected operations to be performed in order to gain unauthorized access to a resource of a plurality of resources of the cloud environment. An entity associated with the cloud environment is notified of an attack on the resource of the cloud environment responsive to identifying the set of log records matching the simulated attack path.

In some implementations, each simulated attack path of the plurality of simulated attack paths is generated by generating, based on a description of a plurality of resources the cloud environment, a model of the cloud environment, utilizing the model to gain access to each resource of the plurality of resources of the cloud environment, and generating a simulated attack path comprising a plurality of expected operation to be performed in order to gain unauthorized access to the resource of the plurality of resources in response to gaining access to a resource of the plurality of resources.

In some implementations, identifying the set of log records matching the simulated attack path of the plurality of simulated attack paths that are applicable to the cloud environment includes identifying, in the event log, a set of log records matching a set of expected log records of the simulated attack path.

In some implementations, the set of expected log records of the simulated attack path is determined by obtaining a plurality of expected operations of a respective simulated attack path for each simulated attack path of the plurality of simulated attack paths, determining whether one or more operations of a respective entry matches one or more expected operations of the plurality of expected operations of the respective simulated attack path for each entry of a plurality of entries of a log conversion data structure, and appending, to a set of expected log records for the respective simulated attack path, an expected log record of the respective entry responsive to determining that the one or more operations of the respective entry matches one or more expected operations of the plurality of expected operations of the respective simulated attack path. Each entry of the plurality of entries may include an expected log record and one or more operations associated with the expected log record.

In some implementations, identifying, in the event log, the set of log records matching the set of expected log records of the simulated attack path includes maintaining, for the simulated attack path, a record occurrence data structure, determining whether the log record matches an expected log record of the set of expected log records for each log record of the event log, setting a flag of an entry of the record occurrence data structure associated with the expected log record responsive to determining that the log record matches an expected log record of the set of expected log records, and notifying that the set of log records matching the set of expected log records of the simulated attack path has been identified responsive to determining that the flag for all entries of the record occurrence data structure is set. Each entry of the record occurrence data structure may correspond to an expected log record of the set of expected log records of the simulated attack path and includes a flag indicating whether a corresponding expected log record occurred in the event log.

In some implementations, the resource of the cloud environment is one of: a compute resource, a storage resource, or a network resource.

In some implementation, notifying the entity associated with the cloud environment of the attack on the resource of the cloud environment includes identifying the resource of the cloud environment and the simulated attack path indicating operations performed to attack the resource of the cloud environment.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the present disclosure.

FIG. 2 illustrates an example simulated attack path used for personalized threat detection, in accordance with implementations of the present disclosure.

FIG. 3A illustrates an example log conversion data structure used for personalized threat detection, in accordance with implementations of the present disclosure.

FIG. 3B illustrates an example record occurrence data structure used for personalized threat detection, in accordance with implementations of the present disclosure.

FIG. 4 depicts a flow diagram of an example method for performing security analytics using a security analytics platform, in accordance with implementations of the present disclosure.

FIG. 5 depicts a block diagram of an example computing device operating in accordance with one or more aspects of the present disclosure, in accordance with implementations of the present disclosure.

### DETAILED DESCRIPTION

Aspects of the present disclosure relate to personalized threat detection. Detecting malicious activity within customers' cloud environments can be challenging. Various detection methods, such as identifying tools, techniques, or procedures (TTPs), behavioral identifiers, and behavioral analytics, often fail to account for the specific environment and risk profile of an organization, resulting in brittle and noisy detections. TTPs are typically used by attackers to access valuable resources of the user's cloud environment, such as an internet protocol, a malicious file hash, etc. Behavioral identifiers are used to detect behavior typically performed by an attacker when accessing valuable resources of the user's cloud environment. For example, creating an alert for when a backup file is deleted due to the fact that attackers frequently delete backup files when performing ransomware attacks. Behavioral analytics detect deviations from a baseline behavior of a typical user or entity, such as creating an alert for when a user logs in from a country they have never logged in from before. These detection methods, however, may unintentionally flag benign activities as malicious. Thus, a significant effort may be required to tune the detection methods to avoid the detection of these benign activities, and in many case burdens customers with the task of investigating each alert.

A security analytics platforms may monitor activity of a customers' cloud environments by comparing security event logs against predefined rules to detect violations. However, these rules may struggle to adapt to the complexity of modern cloud environments and evolving threats, potentially missing critical vulnerabilities. Additionally, simulated attack path analysis tools, which assist in the visualization and analysis of potential attack vectors, may rely on static snapshots that can quickly become outdated and contain sensitive configuration data, posing security risks.

To address these limitations, a security analytics platform may continuously simulate different attack scenarios and generate simulated attack path graphs to provide automatic and real-time insight into potential security weaknesses. These simulations, combined with cyber risk measurement (e.g., attack exposure scores), help identify how attackers could exploit vulnerabilities. In some instances, a security analytics platform may incorporate simulation and cyber risk measurement. The combination of these techniques can address specific areas of risk in the user's cloud environment, such as risky or unneeded permissions, and sensitive data storage. However, while highlighting specific risks in the user's cloud environment, a security analytics platforms may be unable to correlate them with ongoing attempts, resulting in the need for more integrated and dynamic detection capabilities.

Aspects of the present disclosure address the above-described and other deficiencies by identifying an attack on a high value resource of a cloud computing environment based on matching logs records of one or more event logs generated by the cloud computing environment to a simulated attack path. “Event log” may include one or more application logs, middleware logs, operating system logs, network traffic metadata, and/or various other telemetry data generated by components of the cloud computing environment.

The security and analytics platform may analyze the ingested event logs of the cloud environment in order to identify log records that match a simulated attack path. Such a simulated attack path can be employed to gain unauthorized access to one or more resources of the cloud environment.

The security and analytics platform may employ attack path simulation (APS) techniques to create a model of the cloud environment. Such a model may be represented by a graph, each node of which represents a resource of the cloud environment (e.g., a compute instance, a storage instance, a networking component, a database, etc.). Each edge of the graph that connects two nodes may represent a potential accessibility between the two nodes.

The security and analytics platform may simulate actions of a potential attacker by attempting to traverse the graph to gain unauthorized access to a high value resource. The potential attacker is presumed to be persistent and skilled, using known methods and techniques which includes, for example, exploiting vulnerabilities, configurations, network connectivity, social engineering techniques, and/or leaked credentials. Each successful attempt at gaining unauthorized access to one or more resources generates a simulated attack path, which may include one or more operations that can be performed in order to gain unauthorized access to the resources. The security and analytics platform references each of the operations in the simulated attack path using an identifier of each resource accessed during a respective operation in the simulated attack path (e.g., resource identifier). The resource identifier may uniquely identify the resource in the cloud environment.

The security analytics platform may generate, for a given simulated attack path, a set of expected log records which are likely to be generated by various components of the cloud environment in response to preforming the operations of the simulated attack path. Each of the set of expected log records may correspond to one or more resources of the cloud environment referenced by their respective resource identifiers.

The security analytics platform may maintain a log conversion data structure and utilize it for generating the set of expected log records. Each entry of the log conversion data structure may include a sequence of operations (e.g., a sequence) that are typically performed by an attacker in furtherance of a known malicious action and a corresponding log type. Each log type indicates one or more types of resources (e.g., resource type) that can be included in a corresponding log record.

Using the log conversion data structure, the security analytics platform may identify one or more sequences in a respective simulated attack path. For each identified sequence in the respective simulated attack path, a log type is obtained. The security analytics platform extracts, using the obtained log type, a resource identifiers associated with a resource of the resource type. The security analytics platform generates, using the extracted resource identifiers and the log type, an expected log record for a respective sequence of the simulated attack path. The expected log record is a log record that has the extracted resource identifiers in appropriate fields.

The security analytics platform may create, for each simulated attack path, a record occurrence data structure. Each entry of a record occurrence data structure associated with a given simulated attack path may include an expected log record of the set of expected log records associated with the simulated attack path and may further includes a flag indicating whether the expected log record matched an actual log record found in the security logs. The security analytics platform determines whether an expected log record matches a log record in the security logs. If an expected log record from an entry of a record occurrence data structure matches a log record in the security logs, the security analytics platform sets the flag of the entry. In order for an entity associated with the cloud environment to be notified by the security analytics platform that an attacker gained unauthorized access to a high value resource associated with a given simulated attack path the flag of each entry of a record occurrence data structure must be set, notifies an entity associated with the cloud environment. Additionally, the simulated attack path may be indicated in the notification.

Accordingly, aspects of the present disclosure cover techniques that enables customization of threat detection to account for unique risk in the user's cloud environment, thereby reducing the notification of benign activities as malicious and alerting the user of the risk unique to the user's cloud environment when they occur.

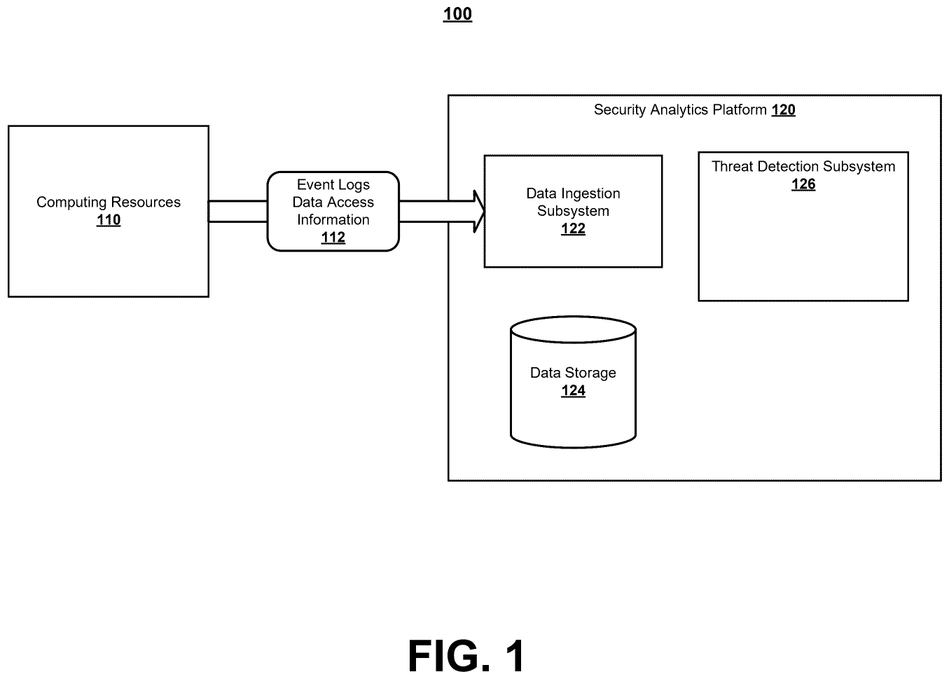

FIG. 1 is a schematic block diagram illustrating an example of system architecture 100 in which one or more aspects of the present disclosure are implemented, in accordance with various embodiments. The system 100 may include computing resources 110. The system 100 may include various types of data access information 112 (event logs, data access information, etc.) provided by the computing resources 110 to a security analytics platform 120 of the system 100. The security analytics platform 120 may include a data ingestion subsystem 122, a data storage 124, a threat detection subsystem 126.

In one or more implementations, the computing resources 110 include a computing system. The computing resources 110 may include a computing system operated by a customer of the entity that operates the security analytics platform 120 and provides security analytics services to the customer. The computing resources 110 may include one or more servers. A server may include a computing device. In some implementations, a computing device includes a physical computing device or includes a virtualized component, such as a virtual machine (VM) or a container. A computing device may include an instance of a computing device. An instance of a computing device may include a spun-up instance that may not be specific to any computing device. In some implementations, a VM may include a system virtual machine, which may include a VM that emulates an entire physical computing device. A VM can include a process virtual machine, which may include a VM that emulates an application or some other software. A container may include a computing environment that logically surrounds one or more software applications independently of other applications executing on the computing resources 110.

The computing resources 110 may include one or more network devices. A network device may include a switch, router, hub, gateway, wireless access point, bridge, modem, repeater, or another type of network device. A network device may help provide data communication between the one or more servers, between other devices of the computing resources 110, or between a computing device external to the computing resources 110 and a device of the computing resources 110. The computing resources 110 may include one or more data storage devices. A data storage device may include a data store. One or more servers or other computing devices of the computing resources 110 can store data on the one or more data storage devices or retrieve data from the one or more data storage devices.

In one or more implementations, the computing resources 110 and the security analytics platform 120 are in data communication with each other over a data network. The data network may include a local area network (LAN), wide area network (WAN), a virtual private network (VPN), or some other data network. The data network may include network devices, including switches, routers, hubs, gateways, wireless access points, bridges, modems, repeaters, or other network devices.

In one implementation, the computing resources 110 and the security analytics platform 120 can execute on different computing systems. In other implementations, at least a portion of the computing resources 110 and the security analytics platform 120 can execute on the same computing system. The computing system may include a cloud computing system. A cloud computing system may include one or more computing devices (or portions of cloud computing devices) provided to an end user by a cloud provider. An end user of the environment may utilize a portion of the cloud computing system to host content for use or access by other parties or perform other computational tasks. In some implementations, the cloud computing system can be configured to allow the end user to use a portion of a computing device (e.g., only certain hardware, software, or other computer system resources). The cloud computing environment may include a private cloud, a public cloud, or a hybrid cloud. The cloud computing environment may provide infrastructure-as-a-service (IaaS), platform-as-a-service (PaaS), or software-as-a-service (SaaS) computing. The cloud computing environment can provide serverless computing.

In some implementations, the data access information 112 provided by the computing resources 110 includes one or more event logs. In some embodiments, the one or more event logs may also be provided by the system architecture 100 (which can host various computing resources). An event log may include a data record that represents an event related to a device or software of the computing resources 110. A device (including a component of a device) can generate the event log, or software can generate the event log. The event log may include data about the event represented by the event log. In some implementations, an event log includes a structured event log. A structured event log may include event data in a structured format. Event data in a structured format may include data that is organized into a recognized format. The structured event log may include event data in a Javascript Object Notation (JSON) format, an Extensible Mark-up Language (XML) format, a comma-separated values (CSV) format, or event data in some other structured format.

In one or more implementations, the data access information 112 includes data access information of the computing resources 110. The data access information may include data that indicates users of the computing resources 110 and what data of the computing resources 110 those users can access. The data access information 112 may include at least a portion of a directory service forest (or data describing at least a portion the directory service forest) of the computing resources 110. A directory service may include a directory service associated with the computing resources 110 that organizes domains, users, computing devices, or security policies of the computing resources 110, authenticates and authorizes the users and devices, and enforces the security policies. A directory service forest may include a logical container that includes the domains, users, computing devices, or security policies, their relationships to each other, their permissions for the computing resources 110, and other data.

In some implementations, the data access information 112 may include identity provider configuration data. An identity provider may include a service that creates, maintains, and manages identity information for users or entities that use the computing resources 110 and may provide authentication services to applications of the computing resources 110. The data access information 112 may include data indicating one or more users, user groups, or domains of the computing resources 110. The data access information 112 may include data indicating one or more access control policies of the computing resources 110. The data access information 112 may include one or more identity and access management (IAM) policies of the computing resources 110 (e.g., where the computing resources 110 include or are a part of a cloud computing system, the IAM policies of the computing resources 110 can include IAM policies of the cloud computing system's provider regarding the computing resources 110).

In some implementations, the data access information 112 includes additional types of data used by the computing resources 110. For example, the data access information 112 may include data loss prevention (DLP) data (e.g., data indicating that event logs from a certain device or certain software of the computing resources 110 include personally identifiable information (PII)). The data access information 112 may include data indicating which devices, software, data, or users of the computing resources 110 are designated as “high value.” The data access information 112 may include results of a vulnerability analysis, penetration test, or other security information of the computing resources 110.

In some implementations, the security analytics platform 120 is a computing platform configured to obtain data from the computing resources 110 and analyze the data in order to detect and respond to security threats on the computing resources 110. The security analytics platform 120 may include a cloud computing system.

In one implementation, the data ingestion subsystem 122 includes software configured to obtain the data access information 112 from the computing resources 110, convert at least a portion of the data access information 112 to a standardized format used by the security analytics platform 120, and store the data in the standardized format in the data storage 124. Because different portions of the data access information 112 may be in different formats, the data ingestion subsystem 122 can convert the data access information 112 into a standardized format used by the platform 120 so the platform 120 can efficiently analyze the converted data access information 112.

The standardized format may include one or more security logs of the platform 120. A security log may include one or more key-value pairs. A security log key may include data that indicates a category of data, and the corresponding value may include data that belongs to that category. The data ingestion subsystem 122 can perform one or more data enrichment operations to generate or modify a security log. For example, the data ingestion subsystem 122 can convert an event log from the computing resources 110 into a security log, and the data ingestion subsystem 122 can then enrich the security log by adding data to the security log based on one or more of the additional types of data discussed above. In some implementations, the data ingestion subsystem 122 does not convert at least a portion of the data access information 112 to a standardized format used by the platform 120 and can use the portion of the data access information 112, in its original format, as one or more security logs.

In one or more implementations, the data ingestion subsystem 122 can store one or more security logs in the data storage 124. The data storage 124 may include a physical storage medium that can include volatile storage (e.g., random access memory (RAM), etc.) or non-volatile storage (e.g., a hard disk drive (HDD), flash memory, etc.). The data storage 124 can include a file system, a database, or some other software configured to store data.

The threat detection subsystem 126 generates a plurality of attack paths for the computing resources 110. The threat detection subsystem 126 generates a graphical representation of the computing resources 110 (e.g., a model of a cloud environment including the computing resources 110). The threat detection subsystem 126 simulates an attacker and attempts to traverse the model exploiting vulnerabilities and misconfigurations, for example, to gain unauthorized access a resource of the computing resources 110.

The threat detection subsystem 126, in response to gaining unauthorized access to a computing resource of the computing resources 110 indicated as high value (e.g., high value computing resource), generates an attack path. The attack path includes a plurality of expected operations (e.g., expected operation set) to be performed in order to gain unauthorized access to the computing resource of the computing resources 110. Each expected operation of the expected operation set includes a computing resource type, a computing resource identifier, an action taken to access the computing resource, and an action taken with the computing resource. Computing resource type indicates a category or nature of the computing resource (e.g., compute instance, database, service key, service account). Computing resource identifier refers to a unique identifier for the computing resource (e.g., a resource identifier, instance identifier, a key identifier, an account identifier, or etc. depending on the computing resources 110). Action taken to access the computing resource describes how the computing resource is accessed, such as credential theft, credential access or etc. Action taken with the computing resource specifies the operation performed on the computing resource, such as accessing account, setting credentials, modifying configurations, or executing code. The threat detection subsystem 126 may store each attack path in the data storage 124.

The threat detection subsystem 126 generates a collection of expected log records for each attack path. Initially, the threat detection subsystem 126 obtains, from a log conversion data structure, a log type for each subset of the expected operation set for a respective attack path. The log conversion data structure maps a plurality of known sequences (e.g., associated with one or more known operations) to corresponding log types. Using the log conversion data structure, the threat detection subsystem 126 identifies, for each sequence present in the respective attack path, a log type. As previously described, each log type indicates one or more computing resource type that will be captured in a log record of the log type. Based on a log type, the threat detection subsystem 126 extracts computing resource identifiers relevant to the log type. The threat detection subsystem 126 generates, using the log type and the extracted computing resource identifier, an expected log record for a respective sequence present.

The threat detection subsystem 126 includes, in a record occurrence data structure associated with the respective attack path, the generated expected log record and a flag. As previously described, the flag is used to track an occurrence of the respective attack path in the security logs. Thus, an expected log record is generated for each sequence present in the respective attack path and stored in the record occurrence data structure associated with the respective attack path. The threat detection subsystem 126 may store the record occurrence data structure for the respective attack path in the data storage 124.

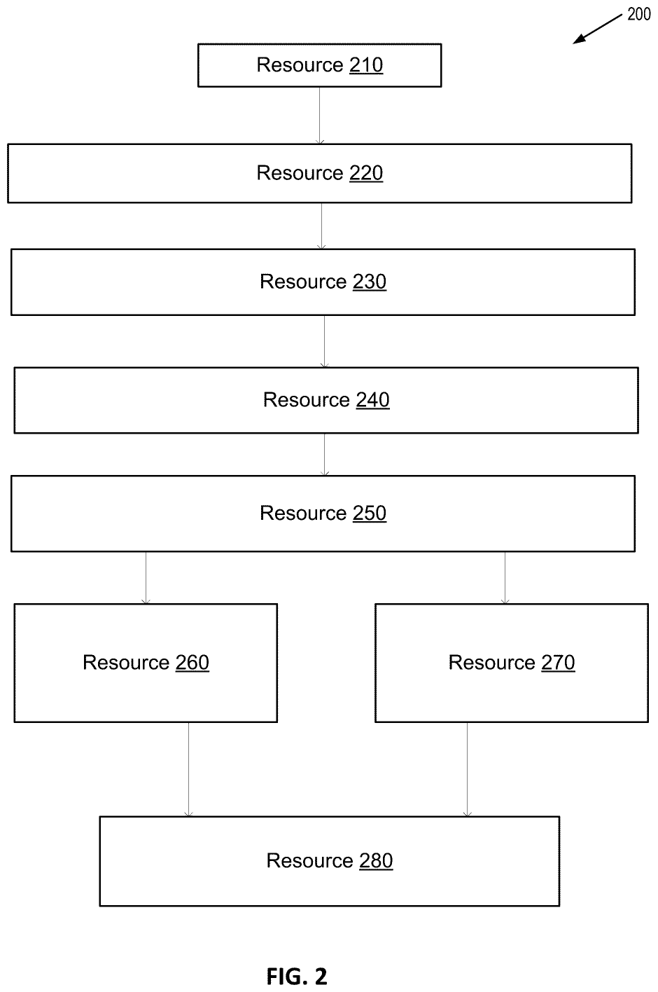

The threat detection subsystem 126 monitors the security logs for an expected log records for each attack path. If a log record of the security logs matches an expected log record for a respective attack path, the threat detection subsystem 126 sets the flag associated with an entry associated with the matching expected log record. The threat detection subsystem 126 determines whether each flag of a record occurrence data structure has been set. If each flag of a record occurrence data structure has been set, the threat detection subsystem 126 notifies an entity of the computing resources 110 that an attack on the computing resources 110 has occurred. The threat detection subsystem 126 may further notify the entity of an attack path associated with the record occurrence data structure. Knowledge of the attack path provides the entity an idea of the operations (based on the expected operation set) that the attacker took to gain unauthorized access to a specific computing resource of the computing resources 110. Details regarding the threat detection subsystem 126 are provided further below in relation to FIGS. 2-4.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 2 illustrates an example expected operation set 200 for an attack path, in accordance with implementations of the present disclosure. The expected operation set 200 for the attack path can include a plurality of expected operations (e.g., expected operations 210-280). As described above, each expected operation of the expected operation set 200 reflects a computing resource type (e.g., type), a computing resource identifier (e.g., identifier), an action taken to access the computing resource (e.g., access action), and an action taken with the computing resource (e.g., resource action).

In some implementation, a first expected operation (e.g., expected operation 210) typically refers to the simulated attacker's entry point into the system, such as the public internet or an exposed service. Intermediate expected operations (e.g., expected operation 220-270) represent various steps taken by the simulated attacker to traverse the computing resources (e.g., computing resources 110 of FIG. 1), exploiting vulnerabilities, or gain elevated privileges. Individually, these expected operations may not be inherently malicious. For instance, accessing a service might be legitimate actions under normal circumstances. A last expected operation (e.g., expected operation 280) represents the final objective of the simulated attacker, often involving a high-value computing resource. This could be a critical database, sensitive information, or key infrastructure component. As described above, while each expected operation might appear benign on its own, performing them in sequence to access and exploit a high-value computing resource (e.g., expected operation 280) demonstrates an attack scenario. In summary, the expected operation set 200 provides a detailed framework to simulate and analyze an attack path.

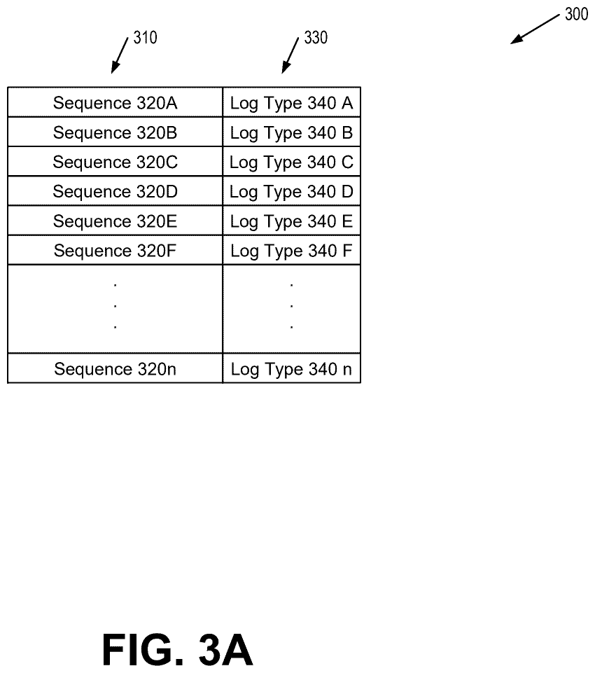

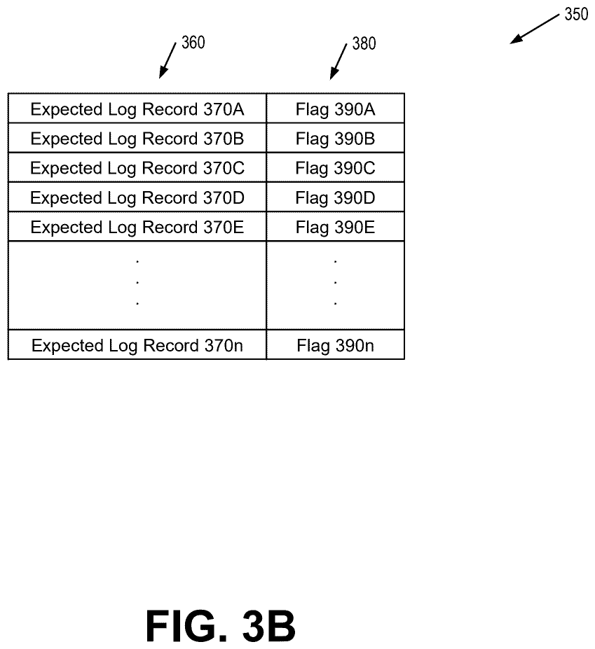

FIG. 3A illustrates an example log conversion data structure 300, in accordance with implementations of the present disclosure. The log conversion data structure 300 may be stored in the data storage 124 of the security analytics platform 120. As previously described, the log conversion data structure 300 maps a plurality of sequences to corresponding log types. The log conversion data structure 300 facilitates the identification of a log type for each subset of operations (e.g., sequence) in an expected operation set (e.g., expected operation set 200 of FIG. 2). Each sequence, representing a subset of operations in an expected operation set (e.g., one or more of the expected operations of the expected operation set), mirrors known malicious actions performed by attackers.

The log conversion data structure 300 is organized using column 310 containing sequences (e.g., sequence 320A-n) and column 330 containing log types (e.g., log type 340A-n). Each row in the log conversion data structure 300 represents a specific pairing between a sequence and its corresponding log type. In operations, the threat detection subsystem 126 begins by examining the expected operation set to see if the expected operation set contains one or more operations associated with a sequence from the log conversion data structure 300. Each sequence of log conversion data structure 300 acts as a search key within the expected operation set. If a sequence from a row of the log conversion data structure 300 is found in the expected operation set, the corresponding log type from column 330 of the row of the log conversion data structure 300 is retrieved for the sequence of the expected operation set to assist in the generation of an expected log record, as will be further discussed below.

FIG. 3B illustrates an example record occurrence data structure, in accordance with implementations of the present disclosure. The threat detection subsystem 126 maintains a plurality of record occurrence data structures. Each record occurrence data structure of the plurality of record occurrence data structures corresponds to an attack path. In an illustrative example, record occurrence data structure 350 corresponds to expected operation set 200 of FIG. 2). Record occurrence data structure 350, for example, monitors security logs by tracking the presence of particular log records as they appear. Each record occurrence data structure of the plurality of record occurrence data structures (e.g., record occurrence data structure 350) is organized using column 360 containing expected log records (e.g., expected log records 370A-n) and column 380 containing flags (e.g., flags 390A-n).

As the threat detection subsystem 126 processes the security logs, it continuously scans for expected log records provided in the plurality of record occurrence data structures. When an expected log record from a row of a record occurrence data structure of the plurality of record occurrence data structures (e.g., record occurrence data structure 350) is identified in the security logs, the threat detection subsystem 126 sets the corresponding flag (e.g., set to true) from column 380 of the row of the record occurrence data structure (e.g., record occurrence data structure 350).

Accordingly, the plurality of record occurrence data structures provides a clear snapshot of which specific log records associated with an attack path have been detected in the security logs at any given time. The threat detection subsystem 126 continuously checks the status of all flags (via column 380 of a respective record occurrence data structure) of the plurality of record occurrence data structures. Once all flags (for a record occurrence data structure of the plurality of record occurrence data structures) are set, indicating that all log records for the attack path associated with the record occurrence data structure have been detected, the threat detection subsystem 126 recognizes that the monitoring criteria are fully met. Thus, the threat detection subsystem 126, triggers a notification to inform an entity of the computing resources (e.g., computing resources 110 of FIG. 1) that all log records for an attack path have been observed.

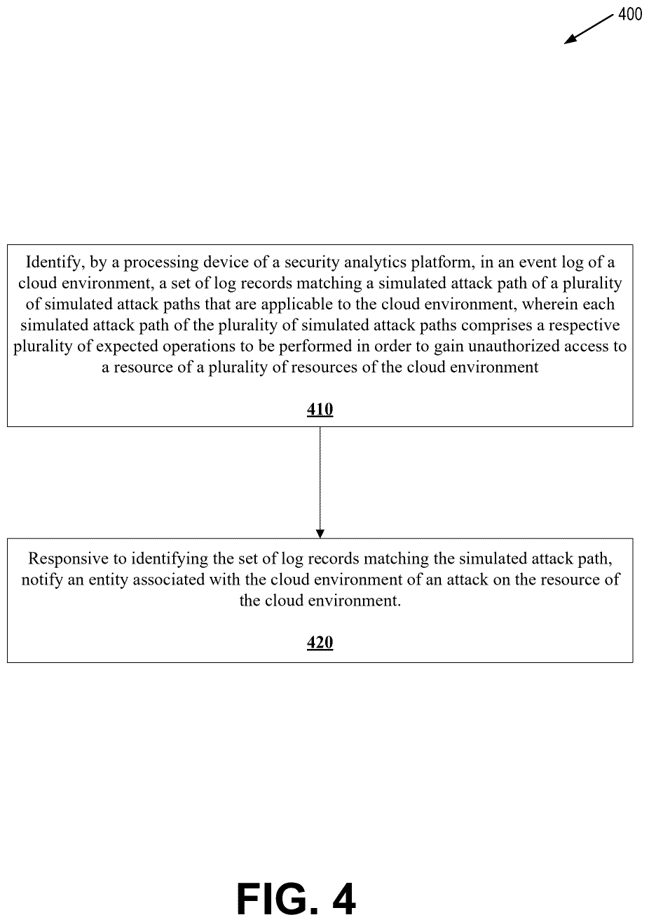

FIG. 4 depicts a flow diagram of a method 400 for personalized threat detection, in accordance with implementations of the present disclosure. Method 400 may be performed by processing logic that may include hardware (circuitry, dedicated logic, etc.), software (e.g., instructions run on a processing device), or a combination thereof. In one implementation, some or all the operations of method 400 may be performed by one or more components of system 100 of FIG. 1 (e.g., threat detection subsystem 126). In one implementation, some or all of the operations of method 400 may be performed by security analytics platform 120.

For simplicity of explanation, the method 400 of this disclosure is depicted and described as a series of acts. However, acts in accordance with this disclosure can occur in various orders and/or concurrently, and with other acts not presented and described herein. Furthermore, not all illustrated acts may be required to implement the method 400 in accordance with the disclosed subject matter. In addition, those skilled in the art will understand and appreciate that the method 400 could alternatively be represented as a series of interrelated states via a state diagram or events. Additionally, it should be appreciated that the method 400 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 410, the processing logic identifies, in an event log of a cloud environment, a set of log records matching a simulated attack path of a plurality of simulated attack paths that are applicable to the cloud environment. Each simulated attack path of the plurality of simulated attack paths may include a plurality of expected operations that can be performed to gain unauthorized access to a high value resource of a plurality of resources of the cloud environment. Each resource of the resource of the cloud environment can be, for example, a compute resource, a storage resource, or a network resource.

As described above, the processing logic each simulated attack path of the plurality of simulated attack paths is generated by generating using a description of a plurality of resources the cloud environment a model of the cloud environment. The processing logic utilizes (e.g., traverses) the model to gain access to each resource of the plurality of resources. In response to gaining access to a high value resource of the plurality of resources, the processing logic generates a simulated attack path. The simulated attack path includes a plurality of expected operation, which when performed by an attacker gains unauthorized access to the high value resource.

The processing logic identifies, in the event log, a set of log records matching a set of expected log records of the simulated attack path. As described above, for each simulated attack path of the plurality of simulated attack paths, the processing logic obtains a plurality of expected operations of a respective simulated attack path. For each entry of a log conversion data structure, the processing logic determines whether one or more operations of a respective entry (associated with a sequence) matches one or more expected operations of the plurality of expected operations of the respective simulated attack path. In other words, whether one or more operations of a respective entry is present in the plurality of expected operations. Each entry of the plurality of entries may further include a corresponding log type. Based on the log type, an expected log record is generated for the one or more operations associated with the one or more expected operations of the plurality of expected operations. The processing logic appends the generated expected log record to a set of expected log records for the respective simulated attack path.

At block 420, responsive to identifying the set of log records matching the simulated attack path, the processing logic notifies an entity associated with the cloud environment of an attack on the resource of the cloud environment.

The processing logic, to identify the set of log records matching the set of expected log records in the event log, maintains a record occurrence data structure for the simulated attack path. Each entry of the record occurrence data structure corresponds to an expected log record of the set of expected log records of the simulated attack path and includes a corresponding flag. The flag indicates whether a corresponding expected log record occurred in the event log. The processing logic, for each log record of the event log, determines whether the log record matches an expected log record of the set of expected log records matches a respective log record. Responsive to determining that the log record matches an expected log record of the set of log records, the processing logic sets a flag of an entry of the record occurrence data structure associated with the expected log record.

Responsive to determining that the flag for all entries of the record occurrence data structure is set, the processing logic notifies an entity of the cloud environment that the set of log records matching the set of expected log records of the simulated attack path has been identified. Depending on the embodiment, notifying the entity associated with the cloud environment includes identifying the resource of the cloud environment and the simulated attack path indicating operations performed to attack the resource of the cloud environment.

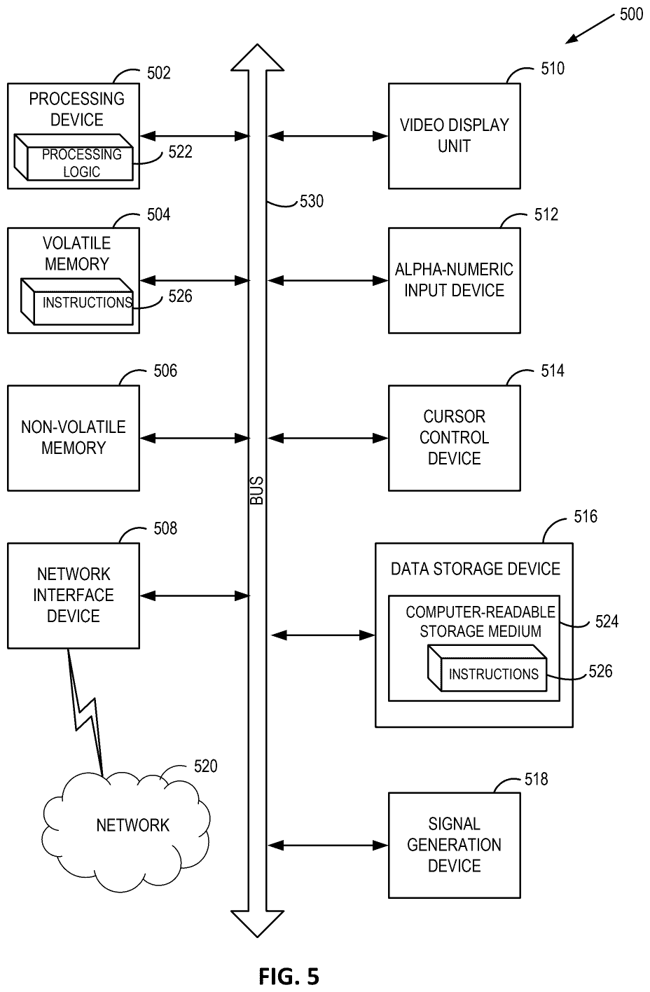

FIG. 5 is a block diagram illustrating an exemplary computer system, in accordance with implementations of the present disclosure. The computer system 500 can be the computing resource 110 and security analytics platform 120 in FIG. 1. The machine can operate in the capacity of a server or an endpoint machine in endpoint-server network environment, or as a peer machine in a peer-to-peer (or distributed) network environment.

The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 505 (e.g., flash memory, static random access memory (SRAM), etc.), and a data storage device 516, which communicate with each other via a bus 530.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 526 (e.g., for user personalized threat detection) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker).

The data storage device 516 can include a non-transitory machine-readable storage medium 524 (also computer-readable storage medium) on which is stored one or more sets of instructions 526 (e.g., for user personalized threat detection) embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 526 include instructions for user personalized threat detection. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying, by a processing device of a security analytics platform, in an event log of a cloud environment, a set of log records matching a simulated attack path of a plurality of simulated attack paths that are applicable to the cloud environment, wherein each simulated attack path of the plurality of simulated attack paths comprises a respective plurality of expected operations to be performed in order to gain unauthorized access to a resource of a plurality of resources of the cloud environment; and
responsive to identifying the set of log records matching the simulated attack path, notifying an entity associated with the cloud environment of an attack on the resource of the cloud environment.

2. The method of claim 1, wherein each simulated attack path of the plurality of simulated attack paths is generated by:
generating, based on a description of a plurality of resources the cloud environment, a model of the cloud environment;
utilizing the model to gain access to each resource of the plurality of resources of the cloud environment; and
in response to gaining access to a resource of the plurality of resources, generating a simulated attack path comprising a plurality of expected operation to be performed in order to gain unauthorized access to the resource of the plurality of resources.

3. The method of claim 1, wherein identifying the set of log records matching the simulated attack path of the plurality of simulated attack paths that are applicable to the cloud environment comprises:
identifying, in the event log, a set of log records matching a set of expected log records of the simulated attack path.

4. The method of claim 3, wherein the set of expected log records of the simulated attack path is determined by:
for each simulated attack path of the plurality of simulated attack paths, obtaining a plurality of expected operations of a respective simulated attack path;
for each entry of a plurality of entries of a log conversion data structure, determining whether one or more operations of a respective entry matches one or more expected operations of the plurality of expected operations of the respective simulated attack path, wherein each entry of the plurality of entries includes an expected log record and one or more operations associated with the expected log record; and
responsive to determining that the one or more operations of the respective entry matches one or more expected operations of the plurality of expected operations of the respective simulated attack path, appending, to a set of expected log records for the respective simulated attack path, an expected log record of the respective entry.

5. The method of claim 3, wherein identifying, in the event log, the set of log records matching the set of expected log records of the simulated attack path comprises:
maintaining, for the simulated attack path, a record occurrence data structure, wherein each entry of the record occurrence data structure corresponds to an expected log record of the set of expected log records of the simulated attack path and includes a flag indicating whether a corresponding expected log record occurred in the event log;
for each log record of the event log, determining whether the log record matches an expected log record of the set of expected log records;
responsive to determining that the log record matches an expected log record of the set of expected log records, setting a flag of an entry of the record occurrence data structure associated with the expected log record; and
responsive to determining that the flag for all entries of the record occurrence data structure is set, notifying that the set of log records matching the set of expected log records of the simulated attack path has been identified.

6. The method of claim 1, wherein the resource of the cloud environment is one of: a compute resource, a storage resource, or a network resource.

7. The method of claim 1, wherein notifying the entity associated with the cloud environment of the attack on the resource of the cloud environment comprises identifying the resource of the cloud environment and the simulated attack path indicating operations performed to attack the resource of the cloud environment.

8. A system, comprising:
a memory device, coupled to the memory, configured to perform operations comprising:
identifying in an event log of a cloud environment, a set of log records matching a simulated attack path of a plurality of simulated attack paths that are applicable to the cloud environment, wherein each simulated attack path of the plurality of simulated attack paths comprises a respective plurality of expected operations to be performed in order to gain unauthorized access to a resource of a plurality of resources of the cloud environment; and
responsive to identifying the set of log records matching the simulated attack path, notifying an entity associated with the cloud environment of an attack on the resource of the cloud environment.

9. The system of claim 8, wherein each simulated attack path of the plurality of simulated attack paths is generated by:
generating, based on a description of a plurality of resources the cloud environment, a model of the cloud environment;
utilizing the model to gain access to each resource of the plurality of resources of the cloud environment; and
in response to gaining access to a resource of the plurality of resources, generating a simulated attack path comprising a plurality of expected operation to be performed in order to gain unauthorized access to the resource of the plurality of resources.

10. The system of claim 8, wherein identifying the set of log records matching the simulated attack path of the plurality of simulated attack paths that are applicable to the cloud environment comprises:
identifying, in the event log, a set of log records matching a set of expected log records of the simulated attack path.

11. The system of claim 10, wherein the set of expected log records of the simulated attack path is determined by:
for each simulated attack path of the plurality of simulated attack paths, obtaining a plurality of expected operations of a respective simulated attack path;
for each entry of a plurality of entries of a log conversion data structure, determining whether one or more operations of a respective entry matches one or more expected operations of the plurality of expected operations of the respective simulated attack path, wherein each entry of the plurality of entries includes an expected log record and one or more operations associated with the expected log record; and
responsive to determining that the one or more operations of the respective entry matches one or more expected operations of the plurality of expected operations of the respective simulated attack path, appending, to a set of expected log records for the respective simulated attack path, an expected log record of the respective entry.

12. The system of claim 10, wherein identifying, in the event log, the set of log records matching the set of expected log records of the simulated attack path comprises:
maintaining, for the simulated attack path, a record occurrence data structure, wherein each entry of the record occurrence data structure corresponds to an expected log record of the set of expected log records of the simulated attack path and includes a flag indicating whether a corresponding expected log record occurred in the event log;
for each log record of the event log, determining whether the log record matches an expected log record of the set of expected log records;
responsive to determining that the log record matches an expected log record of the set of expected log records, setting a flag of an entry of the record occurrence data structure associated with the expected log record; and
responsive to determining that the flag for all entries of the record occurrence data structure is set, notifying that the set of log records matching the set of expected log records of the simulated attack path has been identified.

13. The system of claim 8, wherein the resource of the cloud environment is one of: a compute resource, a storage resource, or a network resource.

14. The system of claim 8, wherein notifying the entity associated with the cloud environment of the attack on the resource of the cloud environment comprises identifying the resource of the cloud environment and the simulated attack path indicating operations performed to attack the resource of the cloud environment.

15. A non-transitory computer-readable medium comprising instructions that, responsive to execution by a processing device, cause the processing device to perform operations comprising:
identifying in an event log of a cloud environment, a set of log records matching a simulated attack path of a plurality of simulated attack paths that are applicable to the cloud environment, wherein each simulated attack path of the plurality of simulated attack paths comprises a respective plurality of expected operations to be performed in order to gain unauthorized access to a resource of a plurality of resources of the cloud environment; and
responsive to identifying the set of log records matching the simulated attack path, notifying an entity associated with the cloud environment of an attack on the resource of the cloud environment.

16. The non-transitory computer-readable medium of claim 15, wherein each simulated attack path of the plurality of simulated attack paths is generated by:
generating, based on a description of a plurality of resources the cloud environment, a model of the cloud environment;
utilizing the model to gain access to each resource of the plurality of resources of the cloud environment; and
in response to gaining access to a resource of the plurality of resources, generating a simulated attack path comprising a plurality of expected operation to be performed in order to gain unauthorized access to the resource of the plurality of resources.

17. The non-transitory computer-readable medium of claim 15, wherein identifying the set of log records matching the simulated attack path of the plurality of simulated attack paths that are applicable to the cloud environment comprises:
identifying, in the event log, a set of log records matching a set of expected log records of the simulated attack path.

18. The non-transitory computer-readable medium of claim 17, wherein the set of expected log records of the simulated attack path is determined by:
for each simulated attack path of the plurality of simulated attack paths, obtaining a plurality of expected operations of a respective simulated attack path;
for each entry of a plurality of entries of a log conversion data structure, determining whether one or more operations of a respective entry matches one or more expected operations of the plurality of expected operations of the respective simulated attack path, wherein each entry of the plurality of entries includes an expected log record and one or more operations associated with the expected log record; and
responsive to determining that the one or more operations of the respective entry matches one or more expected operations of the plurality of expected operations of the respective simulated attack path, appending, to a set of expected log records for the respective simulated attack path, an expected log record of the respective entry.

19. The non-transitory computer-readable medium of claim 17, wherein identifying, in the event log, the set of log records matching the set of expected log records of the simulated attack path comprises:
maintaining, for the simulated attack path, a record occurrence data structure, wherein each entry of the record occurrence data structure corresponds to an expected log record of the set of expected log records of the simulated attack path and includes a flag indicating whether a corresponding expected log record occurred in the event log;
for each log record of the event log, determining whether the log record matches an expected log record of the set of expected log records;
responsive to determining that the log record matches an expected log record of the set of expected log records, setting a flag of an entry of the record occurrence data structure associated with the expected log record; and
responsive to determining that the flag for all entries of the record occurrence data structure is set, notifying that the set of log records matching the set of expected log records of the simulated attack path has been identified.

20. The non-transitory computer-readable medium of claim 15, wherein notifying the entity associated with the cloud environment of the attack on the resource of the cloud environment comprises identifying the resource of the cloud environment and the simulated attack path indicating operations performed to attack the resource of the cloud environment.
